(19) United States
(12) Patent Application Publication
(10) Pub. No.: US 2016/0259583 A1
(43) Pub. Date: Sep. 8, 2016

(54) STORAGE DEVICE, STORAGE DEVICE SYSTEM AND INFORMATION TERMINAL

(71) Applicant: GENUSION INC., Amagasaki-shi (JP)

(72) Inventors: Yasushi KASA, Hyogo (JP); Moriyoshi NAKASHIMA, Hyogo (JP)

(21) Appl. No.: 14/732,118

(22) Filed: Jun. 5, 2015

(30) Foreign Application Priority Data
Jun. 5, 2014 (JP) 2014-116716
Nov. 14, 2014 (JP) 2014-231349

(51) Int. Cl. G06F 3/06

(52) U.S. Cl. CPC G06F 3/0623; G06F 3/0652; G06F 3/0659; G06F 3/0679

(57) ABSTRACT

The present invention has an object of providing a storage device capable of making recovery of erased data difficult and erasing the data safely. Provided is a storage device system including a driver controlling an interface between a nonvolatile memory and an external host; and a second controller located between the nonvolatile memory and a first controller, the second controller detecting a logical address of an old data area for a deleted or overwritten file, the second controller detecting a logical address of an old data area for a deleted or overwritten file. The second controller writes invalid data to the logical address of the old data area for the deleted or overwritten file.

### CROSS-REFERENCE TO RELATED APPLICATIONS

This application is based upon and claims the benefit of priority from the prior Japanese Patent Application No. 2014-116716, filed on Jun. 5, 2014 and the prior Japanese Patent Application No. 2014-231349, filed on Nov. 14, 2014, the entire contents of which are incorporated herein by reference.

### FIELD

The present invention relates to a storage device, a storage device system, and an information terminal, specifically to a storage device and a storage device system each including a nonvolatile memory and improving security so that recovery of a file erased from an application is difficult, and also an information terminal using the same.

### BACKGROUND

Conventionally, files generated by a personal computer or the like are mainly stored on a USB memory or the like using a NAND flash memory. However, a USB memory or the like may be possibly lost. In the case where a file stored thereon includes sensitive information such as private information or the like or business secrets which need to be kept confidential strictly, a serious business loss may be incurred if such a USB memory is lost. In order to avoid such a loss, files are manually erased based on certain criteria, or software including an algorithm for erasing files at a certain timing is implemented on a personal computer.

A USB memory or the like using a NAND flash memory uses a file system by which a storage area is divided into a data area and a file management area. For erasing a file, the file management area is flagged so that it is merely considered that the corresponding file is “erased”. “Deletion” of a file is also referred to as “erasure”, but “erasure” of a file does not necessarily signify erasure of a nonvolatile memory having data of a file written therein. Formatting a medium such as a USB memory or the like merely indicates that the management area is erased and a start address of the file in the data area cannot be specified, which makes it difficult to read the file. The data itself of the file remains in the data area. Therefore, the data of the deleted file may occasionally be recovered by use of an application such as data recovery software or the like.

In order to erase the file so as not to be unrecoverable, fixed data such as FF or 00 needs to be written to the entire data area. Deletion software for this purpose is known. However, when using such an application, the user needs to start the application and perform a deletion operation in accordance with the procedure of the application. This makes it difficult to eliminate a human error.

### SUMMARY

The present invention has an object of providing a storage device (Safe Erase File Memory: SEM) and a storage device system each capable of making recovery of erased data difficult so that the data is erased safely, and an information terminal using the same.

A storage device system in an embodiment according to the present invention includes a driver controlling an interface between a nonvolatile memory and an external host; and a controller located between the nonvolatile memory and a control unit, the controller detecting a logical address of an old data area for a deleted or overwritten file. The controller writes invalid data to the logical address of the old data area for the deleted or overwritten file.

An information terminal in an embodiment according to the present invention includes a storage device in an embodiment according to the present invention.

The present invention provides a storage device and a storage device system each capable of making recovery of erased data difficult so that the data is erased safely, and an information terminal using the same.

### BRIEF DESCRIPTION OF DRAWINGS

FIG. 1 is a block diagram showing a circuit configuration of a storage device in an embodiment according to the present invention;

FIG. 2 is a block diagram showing a circuit configuration of another storage device in an embodiment according to the present invention;

FIG. 3 is a block diagram showing a circuit configuration of a storage device system in an embodiment according to the present invention;

FIG. 4 is a circuit configuration diagram of a storage device in an embodiment according to the present invention which shows a flow of commands transmitted from an external host to the storage device;

FIG. 5 (A) shows a state where contents of a first storage device are changed in accordance with a command issued by a second controller in a first embodiment according to the present invention;

FIG. 5 (B) shows a state where contents of a first storage device are changed in accordance with a command issued by a second controller in a first embodiment according to the present invention;

FIG. 5 (C) shows a state where contents of a first storage device are changed in accordance with a command issued by a second controller in a first embodiment according to the present invention;

FIG. 6 (A) shows conversion between a logical address and a physical address in a third embodiment according to the present invention;

FIG. 6 (B) shows conversion between a logical address and a physical address in a third embodiment according to the present invention;

FIG. 6 (C) shows conversion between a logical address and a physical address in a third embodiment according to the present invention;

FIG. 7 is a block diagram showing a circuit configuration of a storage device in a fifth embodiment according to the present invention;

FIG. 8 is a block diagram showing a circuit configuration of an information terminal in an embodiment according to the present invention;

FIG. 9 is a block diagram showing a circuit configuration of another information terminal in an embodiment according to the present invention;

FIG. 10 (A) shows schematic views each showing a storage device in an embodiment according to the present invention;

FIG. 10 (B) shows schematic views each showing a storage device in an embodiment according to the present invention;

FIG. 11 (A) shows schematic views each showing storage devices in an embodiment according to the present invention implemented as one eMMC package;

FIG. 11 (B) shows schematic views each showing storage devices in an embodiment according to the present invention implemented as one eMMC package;

FIG. 12 (A) shows examples of using storage devices in an embodiment according to the present invention in which a first storage device is detachable;

FIG. 12 (B) shows examples of using storage devices in an embodiment according to the present invention in which a first storage device is detachable;

FIG. 13 (A) shows examples of using storage devices in an embodiment according to the present invention in which a first storage device is detachable;

and

FIG. 13 (B) shows examples of using storage devices in an embodiment according to the present invention in which a first storage device is detachable.

### DESCRIPTION OF EMBODIMENTS

Hereinafter, a storage device according to the present invention will be described. The storage device according to the present invention may be carried out in various different embodiments, and are not to construed as being limited to the following embodiments. In the drawings referred to in the embodiments, the identical parts or the parts having substantially the same functions will bear the same reference signs, and repetition of the same descriptions will be omitted.

Regarding the present invention, each of operations is assumed to be performed on a logical address usable for a storage device unless otherwise specified. In this specification, the expression that a file is “deleted” given with no other specific explanation indicates the following state: as described above, the data area in which data of a file is written is not changed, and a corresponding management area is changed to represent information indicating that the data is deleted. The expression that a file is “overwritten” indicates the following state: data is stored on the same logical address on the file system; or a new data area is assigned and updated file data is stored on the new data area, and an area where old data was stored is released from an assigned state but the data remains at the logical address. The “old data” refers to the entirety of, or a part of, data that has been deleted or overwritten with another data. In the case where data is overwritten with another data at one, same logical address, the capacity (size) of the old data and the capacity (size) of the overwriting data (new data) are not necessarily the same with each other, and the old data may possibly remain. By contrast, in the case where the expression that “data is overwritten in a specific area” or that “data is overwritten in a data area” is provided, the term “overwritten” indicates that data is newly written to the target logical area, such that when data is read from the target logical address, the read data is the newly written data and the data written before the newly written data cannot be read. Namely, the term “overwritten” indicates that all the old data is overwritten with new data and the old data cannot be read at all.

### Overview of the Present Invention

A storage device and a storage device system according to the present invention include a controller that controls a nonvolatile memory (such a controller will be referred to as an “SEM controller”). As the storage device, a typical auxiliary storage device such as, for example, a micro SD card, a hard disc drive (HDD) or the like is used. It should be noted that the storage device may be any device having a function of controlling a nonvolatile memory. For example, a storage device including a detachable nonvolatile memory is encompassed in the “storage device” according to the present invention.

In the present invention, the term “storage device system” represents a concept encompassing the above-described storage device. Namely, the term “storage device” system encompasses a case where a storage device includes an SEM controller, a case where a storage device and an external host both have the function of an SEM controller in a dispersed manner, and a case where an external host includes an SEM controller. Therefore, an embodiment of the storage device system according to the present invention may be directed to a storage device itself, specific functional blocks of a storage device and an external host, or a specific functional block of an external host that controls a nonvolatile memory connected with the external host.

The SEM controller has a function of controlling an interface between the storage device and the external host outer to the storage device, and controls the nonvolatile memory in accordance with a command given from the interface.

Namely, the storage device is connected with the external host via the SEM controller. A basic operation of the storage device is to store, read or delete data by a file system of the external host. In addition, the storage device receives a command issued to be used by the SEM controller itself, and stores or reads data.

The external host includes a driver that controls storage, read or deletion of data by use of the file system via the interface. Namely, the file system included in the external host controls the nonvolatile memory via the driver, the interface and the SEM controller.

The SEM controller may provide a correspondence between a logical address of the file data to be controlled by the above-described file system and a physical address in the nonvolatile memory, and may control storage or read of the data on the nonvolatile memory.

For writing data, the SEM controller receives data from the interface and writes the data to the nonvolatile memory. For reading data, the SEM controller may read data from the nonvolatile memory and transmit the data to the interface.

The SEM controller may be included in the nonvolatile memory, or may be separate from the nonvolatile memory and included in the storage device. Alternatively, the SEM controller may not be located in the storage device but may be located in the external host. In the case of being located in the external host, the SEM controller may be located in the external host as an independent component or may be provided as one function of a CPU in the external host. The SEM controller may include a CPU, a ROM and a RAM, or may include a random logic or an FPGA.

### DESCRIPTION OF EMBODIMENTS

Hereinafter, a storage device and a storage device system in embodiments according to the present invention will be described with reference to the drawings. In the following example, the above-described SEM controller is divided into a first controller as a functional block that controls a nonvolatile memory and a second controller as a functional block that performs control between the storage device and the external host outer to the storage device, for the sake of easy understanding. The control operation of the SEM controller is the same as that in the case where the SEM controller is formed of one body. Needless to say, the SEM controller may be formed of one body.

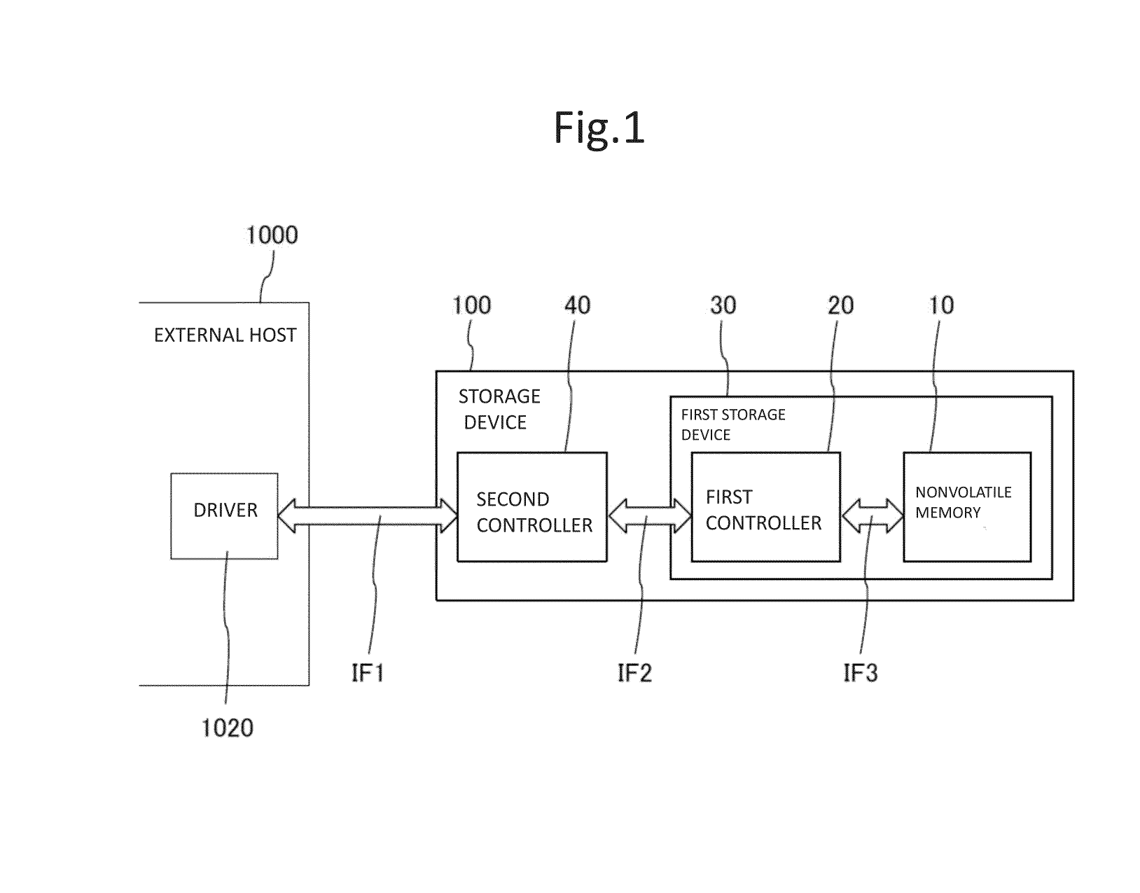

FIG. 1 is a block diagram showing a circuit configuration of a storage device in an embodiment according to the present invention.

A storage device 100 includes a first storage device 30 and a second controller 40. The first storage device 30 includes a nonvolatile memory 10 and a first controller 20 that controls the nonvolatile memory 10. The first controller 20 includes an interface IF3 with the nonvolatile memory 10. As the first storage device 30, a typical auxiliary storage device such as, for example, a micro SD card, a hard disc drive (HDD) or the like is used.

The second controller 40 includes an interface IF1 with an external host 1000 and an interface IF2 with the first storage device 30. The second controller 40 issues a command to the interface IF2 in accordance with a command given from the interface IF1. For writing data, the second controller 40 receives data from the interface IF1 and transmits the data to the interface IF2. For reading data, the second controller 40 receives data from the interface IF2 and transmits the data to the interface IF1. The second controller 40 may include a CPU, a ROM and a RAM, or may include a random logic or an FPGA.

The first storage device 30 is connected with the external host 1000 via the second controller 40. A basic operation of the first storage device 30 is to store, read or delete data by a file system of the external host 1000. In addition, the first storage device 30 receives a command issued to be used by the second controller 40 itself, and stores or reads data.

As seen from the external host 1000, the above-described operation of the storage device may be considered as being the external host 1000 controlling the nonvolatile memory 10 via a driver 1020 located in the external host 1000, the interface IF1, the second controller 40 and the first controller 20.

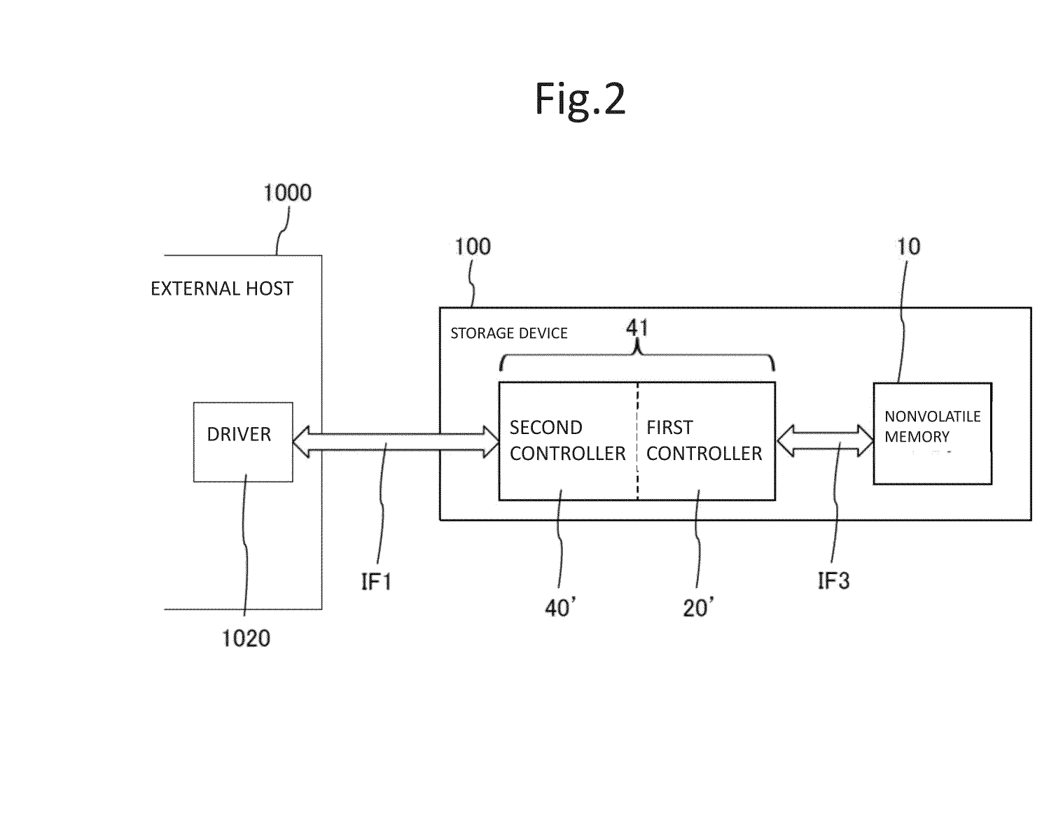

FIG. 2 is a block diagram showing a circuit configuration of another storage device in an embodiment according to the present invention.

In the example described with reference to FIG. 1, the storage device 100 includes the first storage device 30 and the second controller 40, and the first storage device 10 includes the nonvolatile memory 10 and the first controller 20 that controls the nonvolatile memory 10. Alternatively, as shown in FIG. 2, the storage device 100 may include a controller 41, which is an integral body including the second controller 40 that is shown in FIG. 1 as being included in the storage device 100 and being connected with the external host 1000 via IF1, and also include the first controller 20 shown in FIG. 1 that controls the nonvolatile memory 10. In FIG. 2, like in FIG. 1, the external host 1000 includes the driver 1020.

The controller 41 includes the interface IF1 with the external host 1000 and the interface IF3 with the nonvolatile memory 10. The controller 41 is an integral body including a functional block 40′ corresponding to the second controller 40 shown in FIG. 1 and a functional block 20′ corresponding to the first controller 20 shown in FIG. 1. The functional block 40′ and the functional block 20′ are connected with each other via IF2 (not shown). The functional block 20′ and the functional block 40′ respectively perform substantially the same operations as those of the first controller 20 and the second controller 40 described with reference to FIG. 1.

The operations of the interface IF1, the interface IF2 (not shown), the interface IF3 and the nonvolatile memory 10 are substantially the same as those described with reference to FIG. 1.

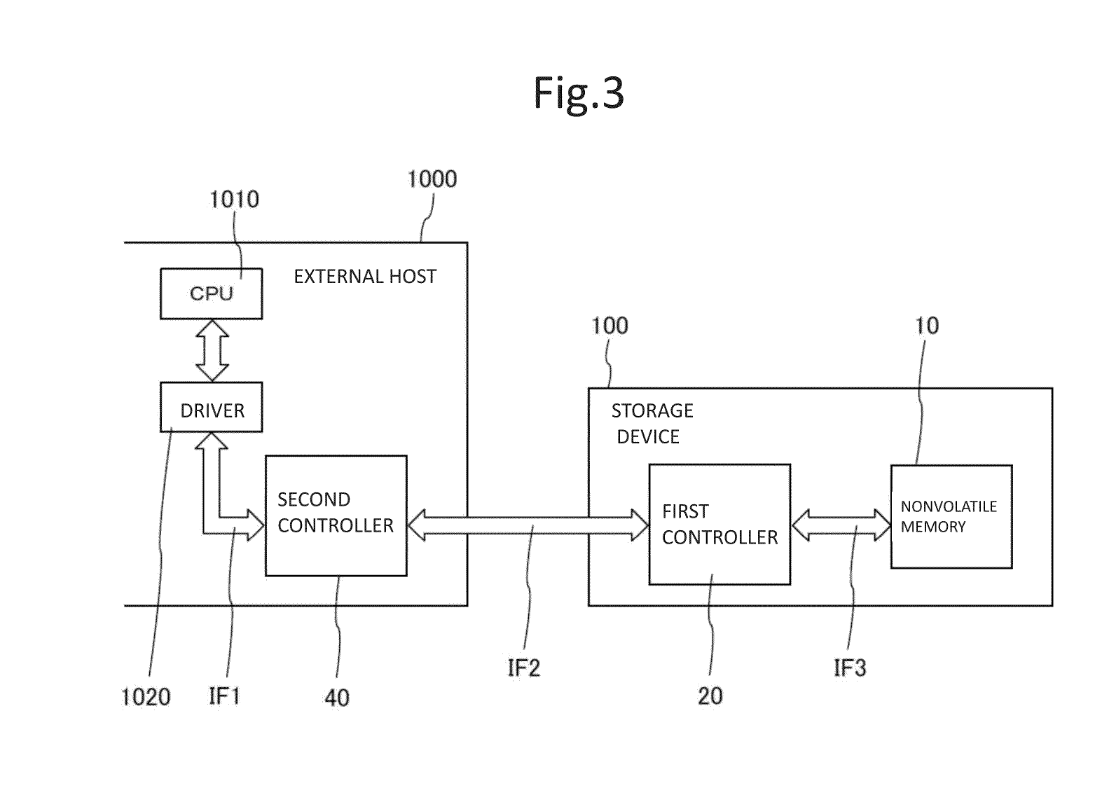

FIG. 3 is a block diagram showing a circuit configuration of a storage device system in an embodiment according to the present invention.

As shown in FIG. 3, the second controller 40 may be included in the external host 1000 located outside the storage device 100. As shown in FIG. 3, the external host 1000 includes the second controller 40, the CPU 1010, the driver 1020 and the interface IF1. The storage device 100 includes the nonvolatile memory 10 and the first controller 20 that controls the nonvolatile memory 10. Thus, the storage device system in this embodiment according to the present invention may include the first controller 20 included in the storage device 100 and the second controller 40 included in the external host 1000.

In this embodiment also, the operations of the second controller 40, the interface IF1, the interface IF2, the first controller 20, the interface IF3 and the nonvolatile memory 10 are substantially the same as those described with reference to FIG. 1.

In the example described with reference to FIG. 3, the Second controller 40 is included in the external host 1000 as an independent block. Alternatively, the second controller 40 may be included in any of the functional blocks in the external host 1000, for example, in the CPU 1010 or the like.

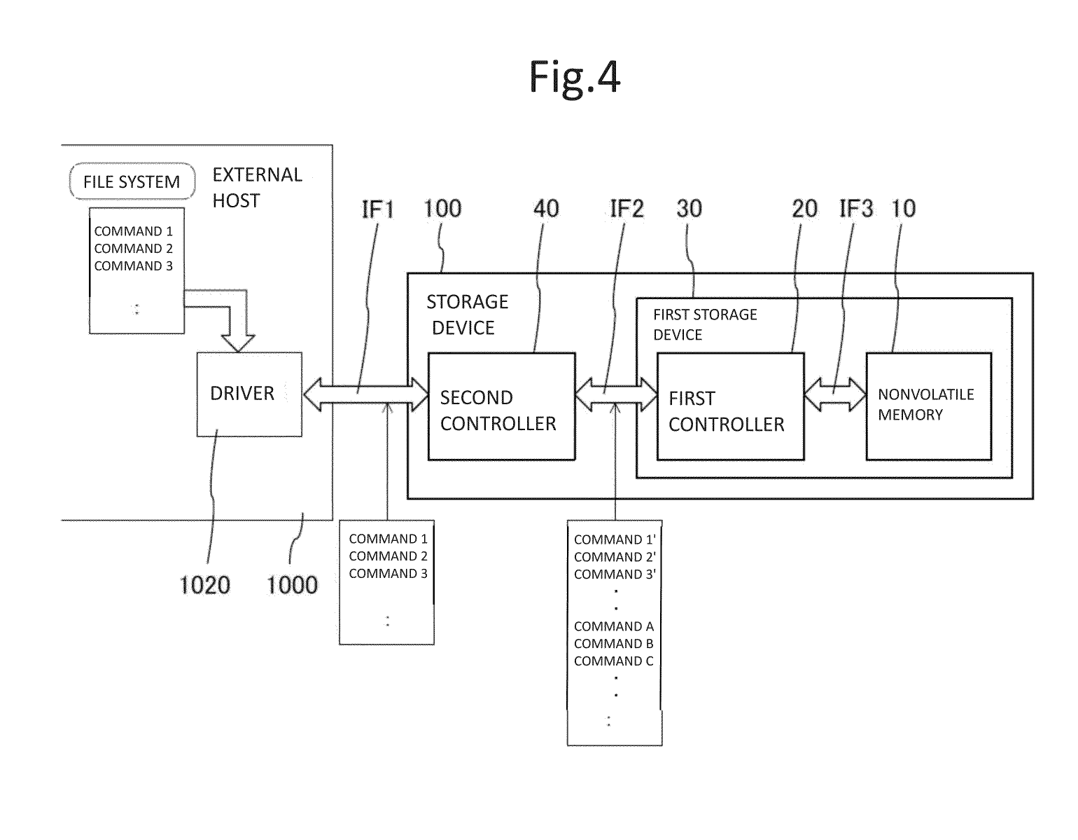

FIG. 4 is a circuit configuration diagram of a storage device in an embodiment according to the present invention which shows a flow of commands transmitted from the external host 1000 to the storage device 100. The structures shown in FIG. 1, FIG. 2 and FIG. 3 perform the same control operation. Thus, the flow of commands will be described regarding the structure shown in the block diagram of FIG. 1.

The file system of the external host 1000 transmits command 1, command 2, command 3, . . . to the storage device 100 via the driver 1020 and the interface IF1. The second controller 40 in the storage device 100 receives command 1, command 2, command 3, . . . , and transmits command 1′, command 2′, command 3′, . . . to the first storage device 30 via the interface IF2. Command 1′, command 2′, command 3′, . . . respectively correspond to command 1, command 2, command 3, . . . received by the second controller 40 and have been converted from command 1, command 2, command 3, . . . so as to be interpretable by the first storage device 30.

The second controller 40 transmits, to the first storage device 30, command 1′, command 2′, command 3′, . . . corresponding to command 1, command 2, command 3, . . . received from the external host 1000, and also transmits command A, command B, command C, . . . issued to be used by the second controller 40 itself to the first storage device 30. On this point, the second controller 40 is different from a chip or the like that merely performs interface conversion. Command A, command B, command C, . . . may be issued together with command 1′, command 2′, command 3′, . . . . Alternatively, command A, command B, command C, . . . may be issued after command 1′, command 2′, command 3′, . . . are transmitted, and after the second controller 40 is put into a state of not receiving any command such as command 1, command 2, command 3, . . . or the like from the external host 1000, namely, after the interface IF1 is put into an idle state. The contents of the commands issued to be used by the second controller 40 itself will be described below.

### Embodiment 1

In embodiment 1 according to the present invention, the second controller 40 includes backup of management information on the first storage device 30. The “management information” is, for example, information that is stored in a root directory area, a sub directory area, a FAT area, a BPB (BIOS Parameter Block) area or the like of, for example, a FAT (File Allocation Table) file system. The management information on the first storage device 30 is managed by the first controller. The second controller 40 receives, from the external host 1000 via the interface IF1, a command to execute file deletion, and transmits a corresponding command to the first storage device 30, and thus file deletion is performed. When this occurs, the management information on the first storage device 30 is rewritten. In this state, a difference occurs between the management information on the first storage device 30 and the backup included in the second controller 40. Therefore, the second controller 40 detects an old data area for the deleted file and specifies an area where the data of the file as a target of deletion is stored. The area specified in this manner is an area managed by a logical address.

The second controller 40 transmits, to the first storage device, a command to write invalid data to the specified area. The invalid data to be written may be data of the same value such as 0x00, 0xFF or the like, or randomly generated data. Namely, the “invalid data” refers to, for example, meaningless data irrelevant to the data written in the specified area before the invalid data is written. After writing the invalid data to the specified area, the second controller 40 updates the backup, so that the backup and the management information on the first storage device 30 match each other.

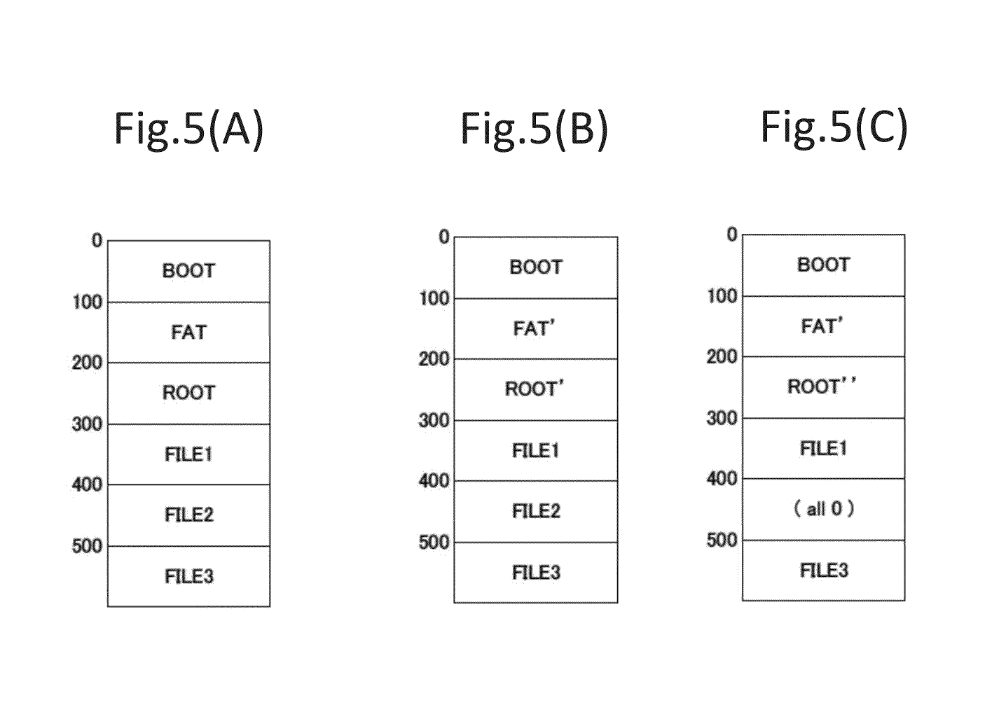

Hereinafter, with reference to FIG. 5, a specific example of commands issued by the second controller 40 will be described.

FIG. 5(A) shows a state where information is stored at each of logical addresses in the first storage device 30. The numerical FIGS. 0 to 500 on the left represent logical addresses. Information on the first storage device 30 is stored in BOOT, data indicating the state of use of the storage area is stored in FAT, and information such as a file name or the like is stored in ROOT. Based on the data read from BOOT, information that FAT starts with logical address 100 and ROOT starts with logical address 200 is acquired. Main content data of a first file is stored in FILE1, Main content data of a second file is stored in FILE2, and Main content data of a third file is stored in FILE3. The second controller 40 issues at least two types of commands, namely, read and write, to the first storage device 30. The read (adrs) command causes data to be read from a logical address (adrs) in the first storage device 30, and the write (adrs) command causes data to be written to a logical address (adrs) in the first storage device 30.

First, commands to be issued and internal processes to be performed in order to allow the second controller 40 to interpret a file system of the first storage device 30 will be described. The second controller 40 issues read 0 to read the contents of BOOT and finds the FAT area and the ROOT area by calculation. Next, the second controller 40 issues read 100 to read the contents of FAT and acquires information on the state of use of the file data. Then, the second controller 40 issues read 200 to read ROOT and acquires information on the file name. When acquiring the information on the state of use of the file data and the information on the file name, the second controller 40 may create backup of such information.

Next, an operation of the second controller 40 of detecting a deleted file will be described. Herein, it is assumed that FILE2 has been deleted. FIG. 5(B) shows the contents of storage after FILE2 is deleted. It is seen that FAT and ROOT have respectively been rewritten to FAT′ and ROOT′ whereas FILE2 is kept as it is. The second controller 40 issues read 100 to read the contents of FAT′ and compares the contents of FAT′ against the backup to check how FAT has been changed. Next, the second controller 40 issues read 200 to read the contents of ROOT′ to check the deleted file and specifies the deleted area.

Now, an operation of the second controller 40 of making the information on the deleted file unrecoverable will be described. FIG. 5(C) shows the contents of storage after the second controller 40 completes the operation of making the information on the deleted file unrecoverable. First, the second controller 40 issues write 400 to write invalid data 0x00 to an area where FILE2 is stored. Next, the second controller 40 issues read 200 to read the contents of ROOT′ to create invalidation data that invalidates the FILE2 information in ROOT′. Then, the second controller 40 issues write 200 to write ROOT″ obtained as a result of processing ROOT′.

As described above, in embodiment 1, the second controller 40 includes the backup of the management information on the first storage device 30, compares the backup and the management information against each other to detect an old data area for the deleted file, and writes invalid data to the detected old data area. Since the storage device 100 writes the invalid data to the area where the data of the file is actually stored, the user is allowed to delete the data safely by merely performing a normal file deletion operation with no use of any special application in the external host 1000.

### Embodiment 2

In embodiment 2, unlike in embodiment 1, the second controller 40 does not include the backup of the management information on the first storage device 30. The second controller 40 receives a file deletion command from the external host 1000 and issues a command regarding normal file deletion to the first storage device 30. Then, in an idle state where the interface IF1 between the external host 1000 and the storage device 100 is not in operation, the second controller 40 analyzes the file system of the first storage device to specify the deleted file and the area where data of the deleted file is stored. In addition, the second controller 40 writes invalid data to the specified area. The invalid data to be written is substantially the same as that in embodiment 1.

As described above, in embodiment 2, in an idle state where the interface IF1 between the external host 1000 and the storage device 100 is not in operation, the storage device 100 analyzes the file system and writes invalid data. Owing to this, embodiment 2 has an advantage of increasing the speed of access as compared with embodiment 1, in which the file is deleted and the invalid data is written when a command to delete the file is received.

In embodiment 1 and embodiment 2 described above, the second controller 40 analyzes the file system of the first storage device to specify the deleted file and the area where the deleted file is stored. In addition, it is shown that the second controller 40 writes the invalid data to the specified area so that recovery of the erased data is made difficult and the data is erased safely.

In a modification, data originally stored in the specified data may be encrypted and the original data may be overwritten with the encrypted data, instead of invalid data being written in the specified data. In this modification, the second controller 40 includes an encryption block. The second controller 40 encrypts the data originally stored in the specified data and overwrites the original data with the encrypted data in the first storage device 30. The encryption block may support a common key encryption system such as, for example, AES, and may be implemented as hardware or an IP core, or may be implemented as software for the second controller 40.

In such a structure, the key encryption used for decryption needs to be managed strictly in order to comply with the gist of the present invention. In the case where the key encryption is strictly managed and kept secret, the user of the storage device merely acquires undecipherable data even when reading the above-described specified area. In this manner, recovery of the data in the specified area is made difficult. A system may be constructed by which in the case where recovery of the data on the storage device is made absolutely necessary for the reason of an accident, a crime or the like, the manager of the key encryption used for decryption may recover the original data.

The key encryption system may be the same as, or different from, the key encryption system in embodiment 5 described below. In the above example, the second controller 40 includes the encryption block. Alternatively, the encryption block may be included in any other controller, needless to say.

### Embodiment 3

In embodiment 3, the second controller 40 treats the first storage device 30 as a memory including virtual physical addresses. The second controller 40 converts a logical address attached to a read/write command received via the interface IF1 into a physical (virtual) address by use of a logical address-physical address conversion table, and performs read or write from or to the post-conversion area.

In this embodiment, like in embodiment 1, the second controller 40 includes backup of the management information on the first storage device 30. The second controller 40 detects an old data area for the deleted file based on the difference between the management information and the backup, and specifies the area where the data of the file as the target of deletion is stored. In addition, the second controller 40 invalidates the correspondence between the logical address of the specified area and the physical (virtual) address. As a result, even if it is attempted to read data from the logical address, the correspondence of which with the physical (virtual) address is invalidated, the stored data is not reached. In this case, the second controller 40 transmits, to the external host 1000, the invalid data, which is predefined data of the same value such as 0x00, 0xFF or the like, or randomly generated data.

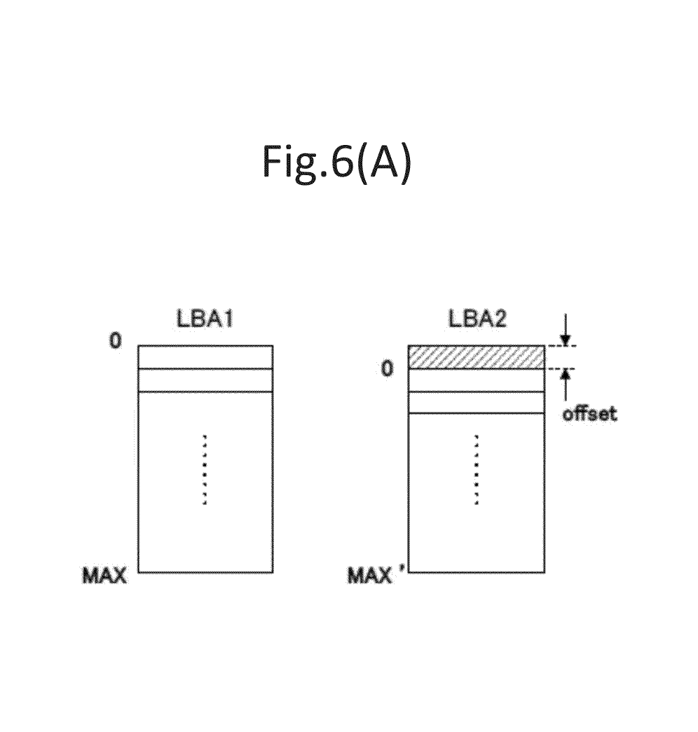

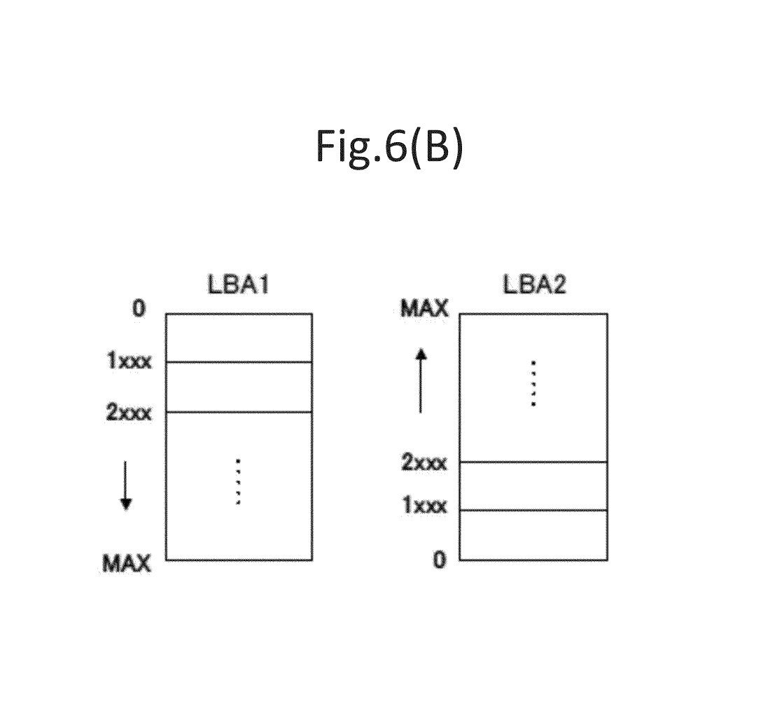

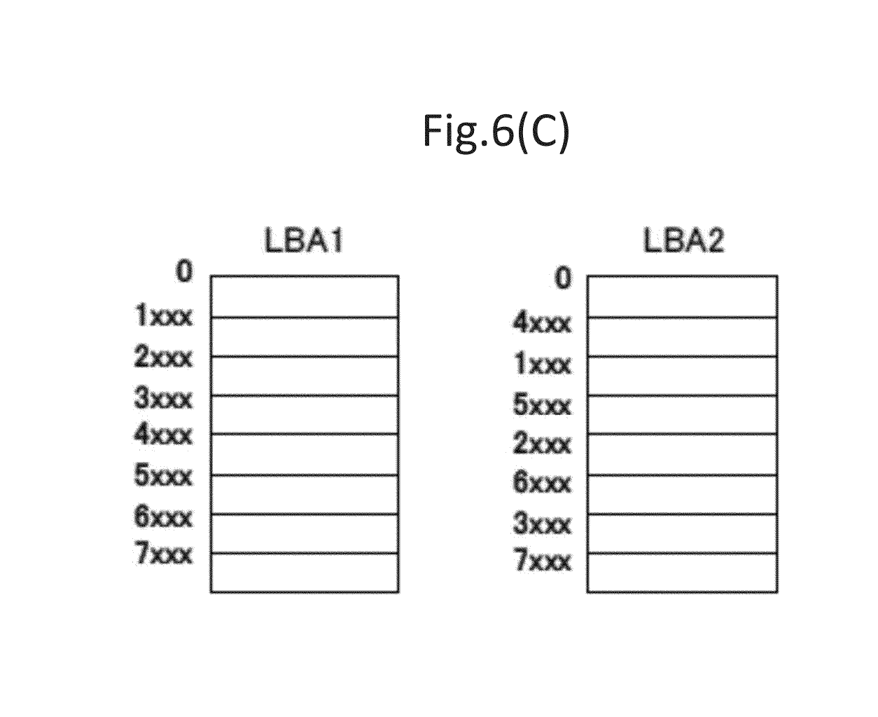

FIG. 6 shows conversion between a logical address and a physical address. In FIG. 6(A) through FIG. 6(C), LBA1 represents a logical address used in the interface IF1, and LBA2 represents a physical (virtual) address used in the interface IF2.

In FIG. 6(A), the positions of the addresses are shifted by a certain value (offset). In this example, LBA2=LBA1+offset. There is a relationship of LBA1 (MAX)=LBA2 (MAX′+offset). The area of the offset of LBA2 is an area that is not accessed from the interface IF1, and may be separately used by the second controller 40. FIG. 6(B) shows an example in which the positions of the addresses are inverted. In this example, LBA2 is obtained as a result of inverting upper bits of LBA1 such that LBA2=LBA1 XOR 0xFFFF0000. FIG. 6(C) shows an example in which the positions of the addresses are swapped. In this example, the conversion is made such that in the case where the upper four bits of the address of LBA1 are abcd, the upper four bits of the address of LBA2 are adbc.

As described above, in embodiment 3, the second controller 40 controls the first storage device 30 by use of the logical address-physical address conversion table, and invalidates the correspondence between the logical address of the area of the deleted file and the physical address. When it is commanded to read data from the area, the correspondence of which with the physical address is invalidated, the second controller 40 transmits predetermined invalid data in return. Since data in the old data area for the deleted file is made unreadable, the deleted file is protected against an attempt of analysis performed by use of an application such as data recovery software or the like. The process of the second controller 40 in embodiment 3 is mainly to cut the correspondence between the logical address and the physical address. Therefore, embodiment 3 has an advantage that the process time is shorter as compared with embodiment 1 or embodiment 2 in which invalid data is written. Embodiment 3 also provides an effect that in the case where it is attempted to read data by removing the first storage device 30 from the storage device 100, it is difficult to recover meaningful data because the addresses have been converted.

### Embodiment 4

In embodiment 4, the second controller 40 holds a part of the management information on the first storage device 30 as a look-up table. Upon receiving a read command from the external host 1000, the second controller 40 refers to the look-up table. When the value indicated by the look-up table represents the deleted area, the second controller 40 does not read data from the first storage device 30 and transmits predetermined invalid data to the external host 1000 in return. The contents of the invalid data are substantially the same as those in embodiment 3.

Embodiment 4 may be combined with embodiment 1. In the case where the second controller 40 receives a read command to read data from the old data area for the deleted file while writing invalid data to the old data area, the second controller 40 transmits predetermined invalid data in return.

Embodiment 4 may be combined with embodiment 2. The area to which invalid data is to be written is specified on the stage where the second controller 40 has analyzed the file system. Therefore, based on such information, the look-up table is created. In the case where the second controller 40 receives, while writing invalid data, a command to read data from the area to which the invalid data is being written, the second controller 40 transmits predetermined invalid data in return.

As described above, in the case where embodiment 4 is combined with embodiment 1 or embodiment 2, even while invalid data is still being written, data of the deleted file is not read. The invalid data may be transmitted to the external host 1000 in return after the write of the invalid data is once stopped or while the invalid data is being written. Therefore, the response speed is increased.

### Embodiment 5

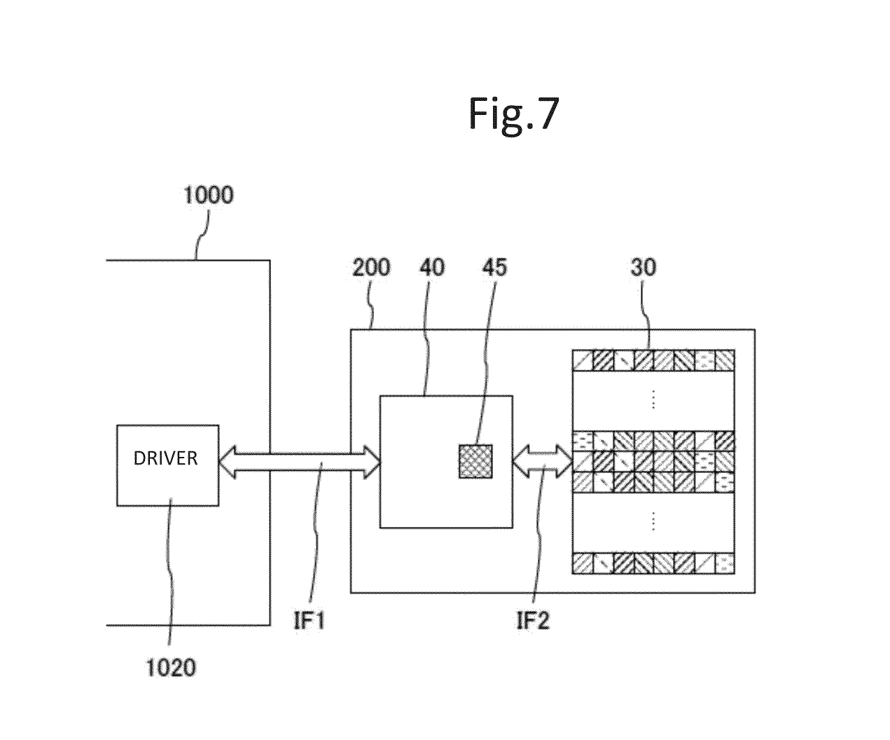

FIG. 7 is a block diagram showing a circuit configuration of a storage device 200 in embodiment 5 according to the present invention. The second controller 40 in the storage device 200 includes an encryption block 45. The storage device 200 receives write data from the external host 1000 via the driver 1020 included in the external host 1000 and the interface IF1. The second controller 40 encrypts the received write data and writes the encrypted write data to the first control device 30. The second controller 40 decrypts the data read from the first storage device 30 and transmits the decrypted data to the external host 1000. The first storage device 30 in FIG. 7 is in the state where the stored data is encrypted. The encryption block 45 may support a common key encryption system such as, for example, AES, and may be implemented as hardware or an IP core, or may be implemented as software for the second controller 40.

Embodiment 5 may be used in combination with any of embodiment 1 through embodiment 4 described above. The encryption makes analysis of the data of the deleted file more difficult.

### <Implementation Form 1>

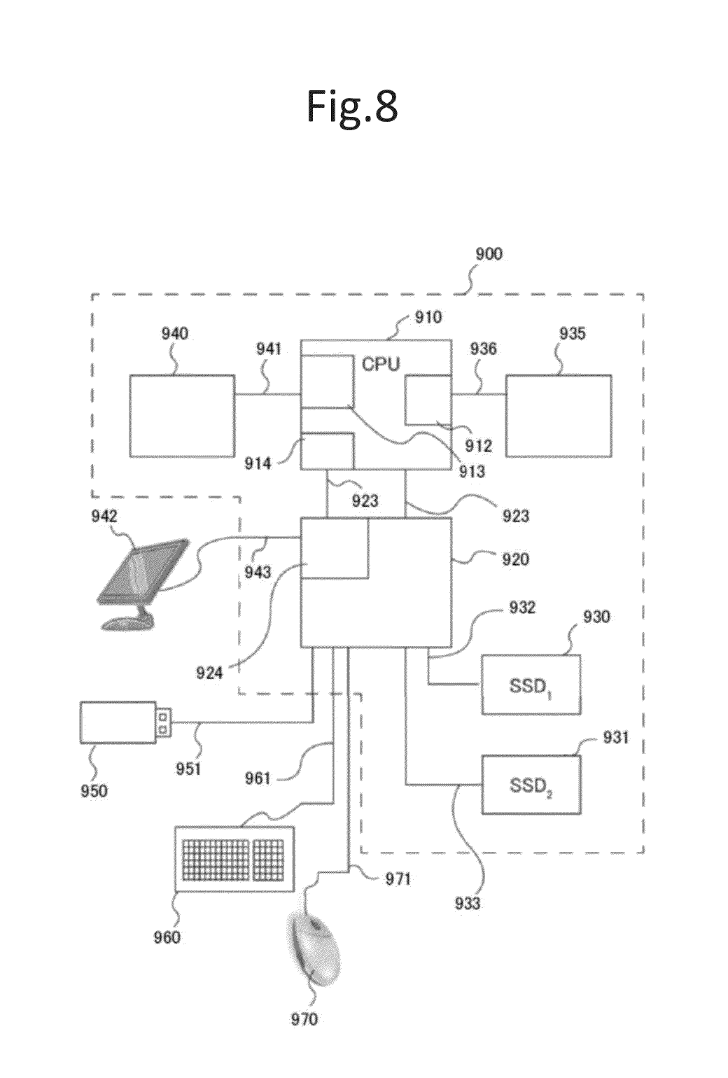

Hereinafter, implementation forms according to the present invention will be described. FIG. 8 is a block diagram showing a circuit configuration of an information terminal 900 in an embodiment according to the present invention. The information terminal 900 is in the form of, for example, a desk top PC, a notebook PC, a tablet PC or the like.

The information terminal 900 may be connected with a display 942, a USB memory 950, a keyboard 960, or a mouse 970.

The information terminal 900 includes a CPU 910 that performs a computation process, a chip set 920 that provides interface with an external device, semiconductor drives 930 and 931 that store programs (operating system, device driver, and application software) and user data, a main memory 935 that temporarily stores the program and the user data described above that may be targets of computation performed by the CPU, and a graphic unit 940 that performs an imaging process.

The CPU 910 includes a memory controller 912 connected with the main memory 935 via a memory bus 936, a graphic bus controller 913 connected with the graphic unit 940 via a graphic bus 941 (e.g., PCI Express 2.0), and a built-in graphic controller 914.

The chip set 920 and the CPU 910 are connected with each other via CPU buses 923 (e.g., DMI 2.0). The chip set 920 includes a display interface 924 that receives data from the built-in graphic controller 914 in the CPU 910 or the graphic unit 940 via the CPU bus 923 and outputs the received data to the display 942 via a display output bus 943. The chip set 920 is also connected with the semiconductor drives 930 and 931 respectively via serial buses 932 and 933 (e.g., SATA 3.0). The USB memory 950, the keyboard 960 and the mouse 970 are connected with the chip set 920 respectively via serial buses 951, 961 and 971 (e.g., USB 3.0).

The semiconductor drive 930 or 931 in the information terminal 900 may be formed of the storage device described with reference to FIG. 1 or FIG. 2. The semiconductor drive 930 or 931 detects the old data area for the deleted file and writes invalid data to the old data area for the deleted file as described above. Alternatively, the semiconductor drive 930 or 931 detects the old data area for the deleted file, and outputs predetermined invalid data upon receiving a read command to read data from the old data area for the deleted file.

In the case where, for example, the semiconductor drive 930 in the information terminal 900 is a normal SSD and the semiconductor drive 931 in the information terminal 900 is a storage device according to the present invention, an operating system and a semiconductor drive device driver may be mainly stored on the semiconductor drive 930 whereas user data may be stored on the semiconductor drive 931. The semiconductor drive device driver may write invalid data to the old data area for the deleted file in the semiconductor drive 931. Alternatively, for example, a program that controls the CPU 910 and the chip set 920, so as to detect the old data area for the deleted file and to transmit a read command to read data from the old data area for the deleted file, may be included in the semiconductor drive 930 or the semiconductor drive 931. In this case, the CPU 910 or the chip set 920 to be controlled by the program acts as the above-described controller.

The USB memory 950 may be formed of the storage device shown in FIG. 1, FIG. 2 or FIG. 3. The USB memory 950 detects the old data area for the deleted file and writes invalid data to the old data area for the deleted file as described above. Alternatively, the USB memory 950 detects the old data area for the deleted file, and outputs predetermined invalid data upon receiving a read command to read data from the old data area for the deleted file.

The semiconductor drive 930 may include a USB memory driver, and the USB memory driver may write invalid data to the old data area for the deleted file in the USB memory 950 as described above. Alternatively, a program that controls the CPU 910 and the chip set 920, so as to detect the old data area for the deleted file and to transmit a read command to read data from the old data area for the deleted file, may be included as the above-described controller.

The semiconductor drive 930 may be formed of the storage device shown in FIG. 1 or FIG. 2.

Owing to having the above-described structure, the information terminal 900 in an embodiment according to the present invention safely erases user data which may include sensitive information such as private information or the like or business secrets which need to be kept confidential strictly, so that recovery of the erased data is difficult.

### <Implementation Form 2>

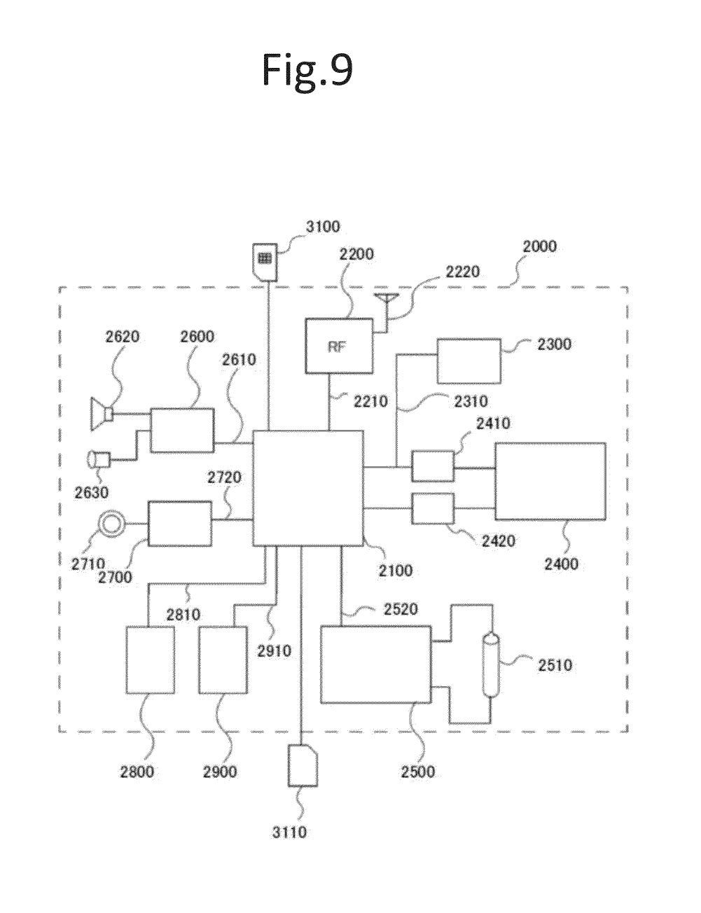

FIG. 9 is a block diagram showing a circuit configuration of an information terminal 2000 in an embodiment according to the present invention. The information terminal 2000 is in the form of, for example, a mobile phone, a smart phone, or a tablet mobile terminal.

The information terminal 2000 includes a slot into which a SIM card 3100 or a USB memory 3110 each storing communication information is insertable.

The information terminal 2000 includes an application processor 2100 that performs a computation process, a wireless communication unit 2200, a sensor 2300, a display 2400, a power source management unit 2500, an audio unit 2600, a camera module 2700, a first memory 2800 formed of a volatile memory, and a second memory 2900 formed of a nonvolatile memory that stores programs (operating system, drive driver, and application software) and user data.

The wireless communication unit 2200 controls communication between the information terminal 2000 and an external wireless base station, and is connected with the application processor 2100 via a serial bus 2210. The wireless communication unit 2200 is also connected with an antenna 2220.

The sensor 2300 includes a temperature sensor, an acceleration sensor, a position sensor, a gyrosensor or the like. Information detected by such a sensor is supplied to the application processor 2100 via a serial bus 2310 (e.g., I2C).

The display 2400 is a liquid crystal display or an organic EL display each having a touch panel function, and is connected with the application processor 2100 via a display interface unit 2420 and a touch panel interface unit 2410.

The power source management unit 2500 is connected with a lithium ion battery 2510, and controls power supply to all the units in the information terminal 2000 and charge/discharge of the lithium ion battery 2510. The power source management unit 2500 is connected with the application processor 2100 via a serial bus 2520 (e.g., I2C).

The audio unit 2600 is connected with a speaker 2620 and a microphone 2630, and is connected with the application processor 2100 via a serial bus 2610 (e.g., I2C).

The camera module 2700 is connected with a two-dimensional CMOS sensor 2710, and is connected with the application processor 2100 via a serial bus 2720 (e.g., CSI).

The first memory 2800 formed of a volatile memory is connected with the application processor 2100 via a memory bus 2810. The first memory 2800 and the application processor 2100 may be stacked together and put into one package. The first memory 2800 temporarily stores programs (operating system and application software) and user data that may be targets of computation.

The second memory 2900 formed of a nonvolatile memory is connected with the application processor 2100 via a memory bus 2910 (e.g., USB 3.0). The second memory 2900 and the application processor 2100 may be stacked together and put into one package. The second memory 2900 stores programs (operating system and application software) and user data.

The second memory 2900 is formed of the storage device shown in FIG. 1, FIG. 2 or FIG. 3. The second memory 2900 detects the old data area for the deleted file and writes invalid data to the old data area for the deleted file as described above. Alternatively, the second memory 2900 detects the old data area for the deleted file, and outputs predetermined invalid data upon receiving a read command to read data from the old data area for the deleted file.

As described above, the second memory 2900 stores the operating system as well as the semiconductor drive device driver (which may be one element of the operating system) and the user data. The semiconductor drive device driver writes invalid data to the old data area for the deleted file in the second memory 2900. Alternatively, a program that controls the application processor 2100, so as to detect the old data area for the deleted file and to transmit a read command to read data from the old data area for the deleted file, may be included as the above-described controller.

The USB memory 3110 is formed of the storage device shown in FIG. 1, FIG. 2 or FIG. 3. The USB memory 3110 detects the old data area for the deleted file and writes invalid data to the old data area for the deleted file. Alternatively, the USB memory 3110 detects the old data area for the deleted file, and outputs predetermined invalid data upon receiving a read command to read data from the old data area for the deleted file.

The second memory 2900 may include a USB memory driver, and the USB memory driver may write invalid data to the old data area for the deleted file in the USB memory 950. Alternatively, a program that controls the application processor 2100, so as to detect the old data area for the deleted file and to transmit a read command to read data from the old data area for the deleted file, may be included as the above-described controller.

Owing to having the above-described structure, the information terminal 2000 in an embodiment according to the present invention safely erases user data which may include sensitive information such as private information or the like or business secrets which need to be kept confidential strictly, so that recovery of the erased data is difficult.

### <Implementation Form 3>

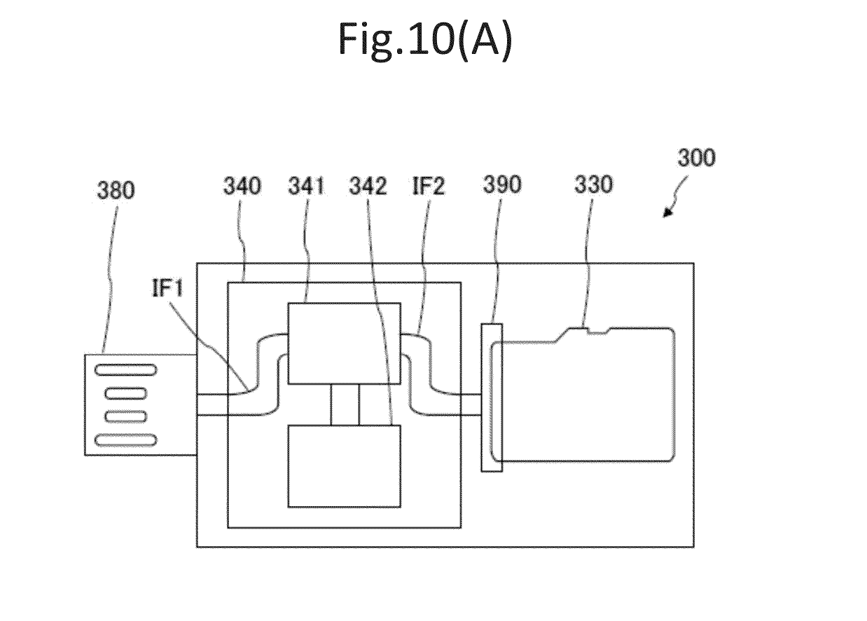

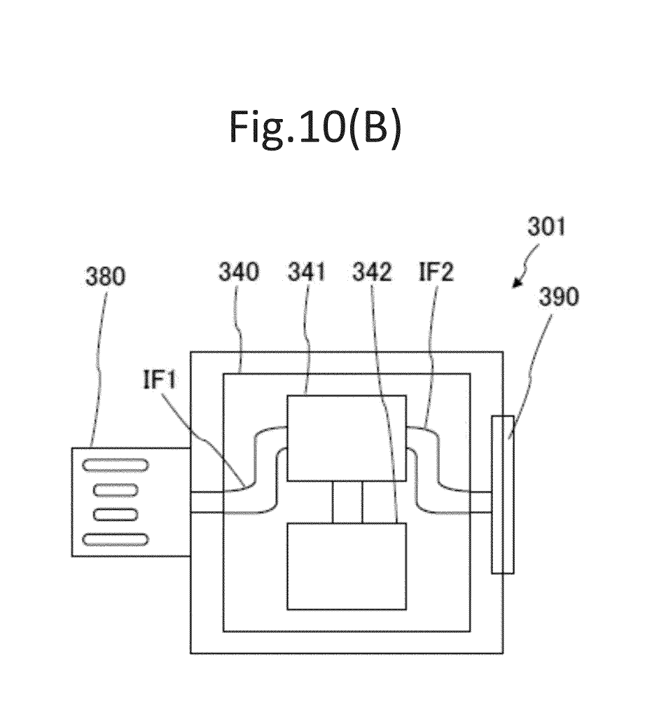

FIG. 10(A) is a schematic view of a storage device in an embodiment according to the present invention. FIG. 10(A) shows a structure of the storage device which is implemented as a USB memory 300. A second controller 340 including a CPU 341 and a RAM 342 is connected, via the interface IF1, with a connection terminal 380 connected with an external host. The second controller 340 is connected, via the interface IF2, with a connector 390 compatible to a micro SD card. In this example, the interface IF1 is a USB interface, and the interface IF2 is an SD interface.

The micro SD card 330 corresponds to the first storage device 30 (not shown) according to the present invention, and is attached to the USB memory 300 with the connector 390. The micro SD card 330 may be detachable or fixed.

FIG. 10(A) shows the micro SD card 330 as a component corresponding to the first storage device 30 (not shown) according to the present invention. Alternatively, a standard memory for USB, SD or the like is usable. In such a case, the connection terminal 380 may be a standard connection terminal for USB, micro SD, SD or the like. The connector 390 may be formed of a standard connector for USB, micro SD, SD or the like.

FIG. 10(B) is also a schematic view of a storage device in an embodiment according to the present invention. The embodiment shown in FIG. 10(B) will be described as an “SEM controller unit 301”. The SEM controller unit 301 includes the second controller 340, the connection terminal 380 connected with an external host, and the connector 390. Unlike in FIG. 10(A), the SEM controller unit 301 does not have a space to which the first storage device 30 (not shown) according to the present invention is attachable. The first storage device 30 (not shown) may be, for example, a typical USB memory or micro SD card. The SEM controller unit 301 includes the connector 390 and is connected with a connection terminal part such as a USB memory or the like.

In FIG. 10(B) also, as described with reference to FIG. 10(A), the connection terminal 380 may be a standard connection terminal for USB, micro SD, SD or the like. The connector 390 may be formed of a standard connector for USB, micro SD, SD or the like.

The SEM controller unit 301 may be in a case form, a cover form, a card form or any other form. For example, the SEM controller unit 301 may be in a form of a USB extension cable. In this case, the second controller 340 may be located in the vicinity of either terminal, or may be located in the vicinity of the terminal on the external host side and the terminal on the existing USB memory side in a dispersed manner. The user attaches the SEM controller unit 301 in any of the above-described forms to an existing PC and connects an existing USB memory to the connector 390 of the SEM controller unit 301. In this manner, the user can enjoy the effect that recovery of the deleted data is difficult and the data is safely erased, by use of the existing resources. The SEM controller unit 301 and an existing USB may be integrated together into, for example, a cap form that can be, for example, used, stored and transported. In this case, the existing USB memory may be used as a memory compatible to the SEM controller.

### <Implementation Form 4>

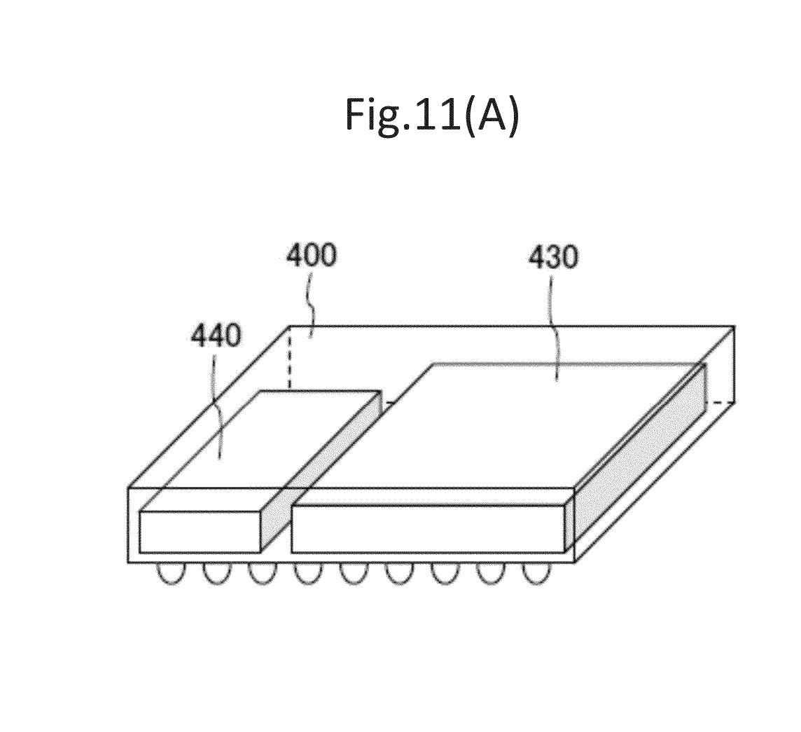

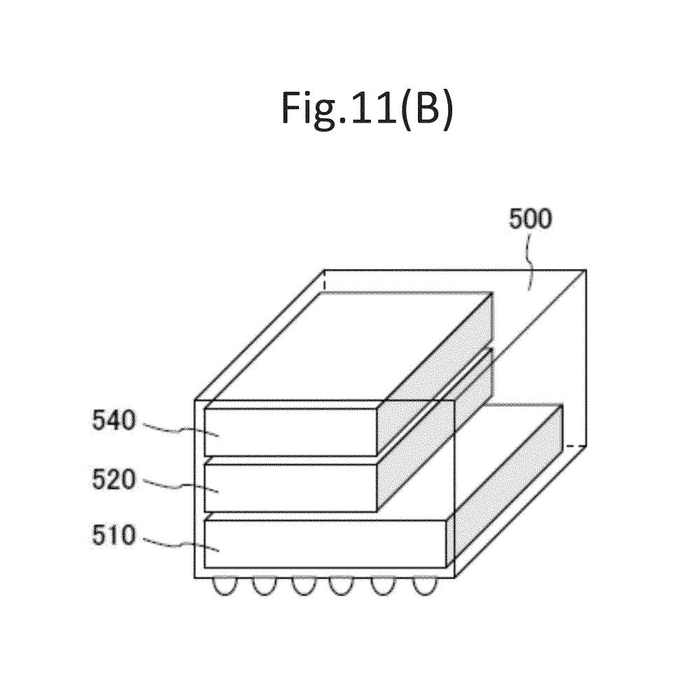

FIG. 11 shows schematic views of storage devices in an embodiment according to the present invention implemented as one eMMC (Embedded Multi Media Card) package. FIG. 11(A) shows an eMMC package 400 including an eMMC package 430 and a second controller 440 that are sealed together. FIG. 11(B) shows an eMMC package 500 including a NAND flash memory 510, an eMMC package 520 and a second controller 540 that are stacked and sealed together. The combination of the NAND flash memory 510 and the eMMC package 520 corresponds to an eMMC of the conventional art. In the eMMC packages 400 and 500, the interfaces IF1 and IF2 are each an eMMC interface.

### Application Example 1

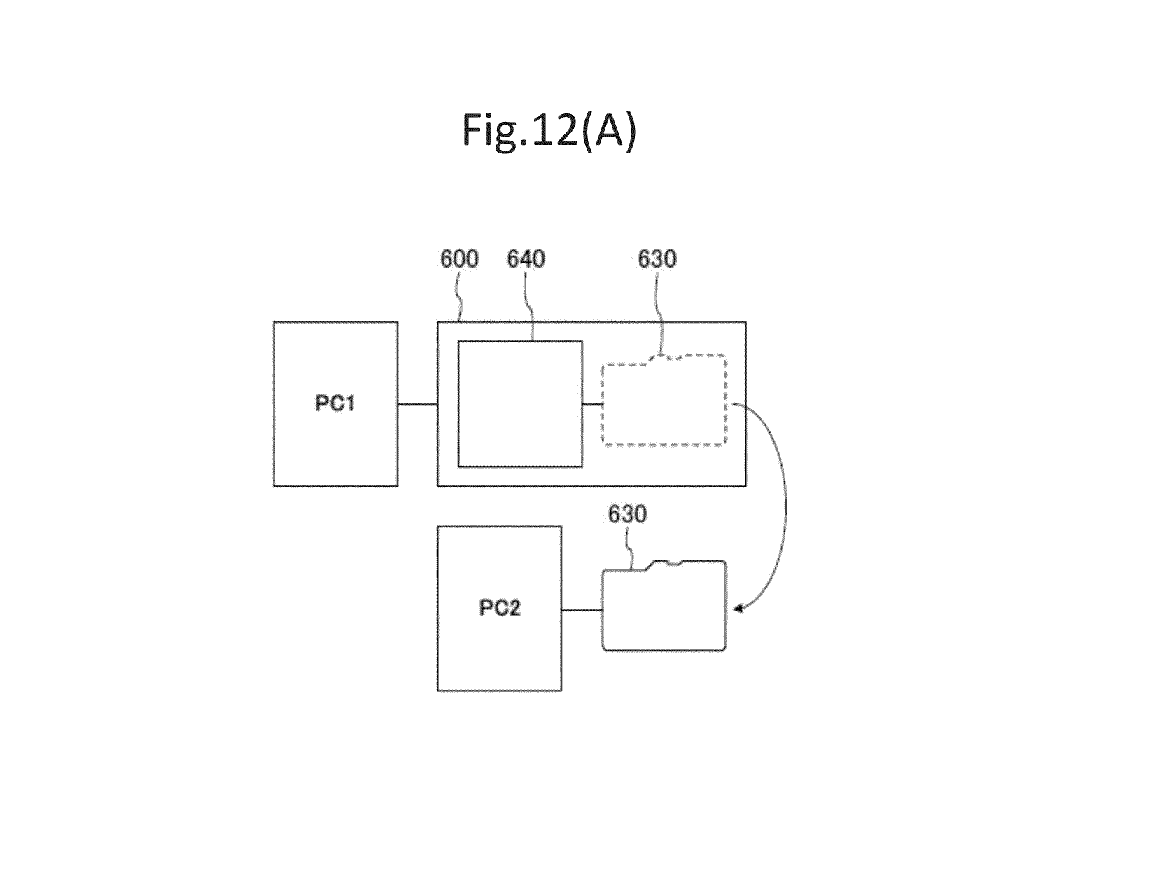

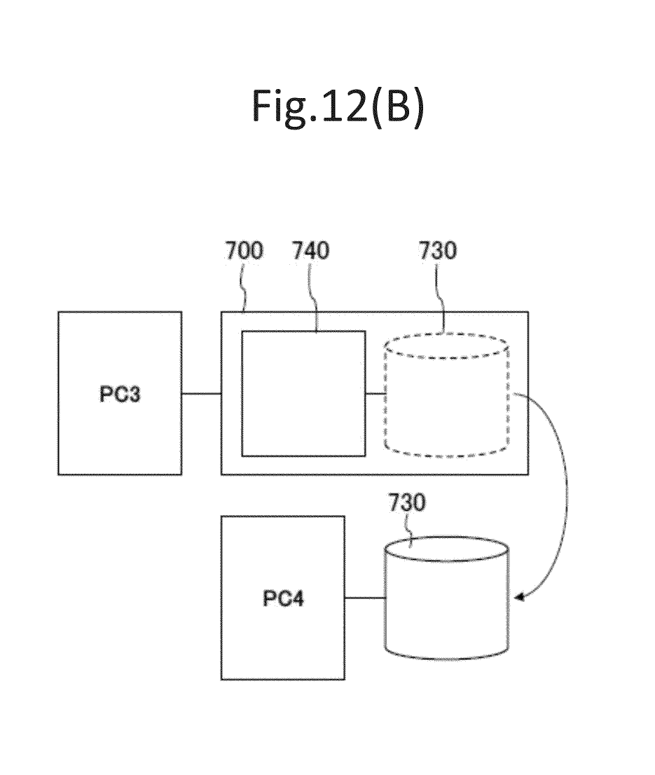

Hereinafter, application examples of the present invention will be described. FIG. 12 shows examples of use of storage devices in an embodiment according to the present invention. In FIG. 12, the first storage device is detachable. An upper part of FIG. 12(A) shows a state where a storage device 600 including a second controller 640 and a detachable micro SD card 630 is connected with a personal computer PC1. A lower part of FIG. 12(A) shows a state where the micro SD card 630 is detached from the storage device 600 and is connected to another personal computer PC2. Like FIG. 12(A), FIG. 12(B) shows a state where a storage device 700 includes a second controller 740 and a detachable HDD 730 and is connected with a personal computer PC3, and the HDD 730 is detached from the personal computer PC3 and is connected to another personal computer PC4.

As shown in FIG. 12, the detachable micro SD card 630 or the detachable HDD 730 may be connected to PC2 or PC4, which is another external host. In this case, as long as the process of writing valid data is performed as in embodiment 1 or embodiment 2, recovery of the data of the file deleted by PC2 or PC4 may be made impossible. In this case, the storage device 600 or 700 merely writes invalid data to the old data area for the deleted file in the SD card 630 or the HDD 730. Therefore, the detached micro SD card 630 or the detached HDD 730 is usable as being connected with any host compatible thereto. In the case where the method of use described in application example 1 is performed, the conversion between the logical address and the physical address described in embodiment 3 or the encryption process described in embodiment 5 is not performed.

### Application Example 2

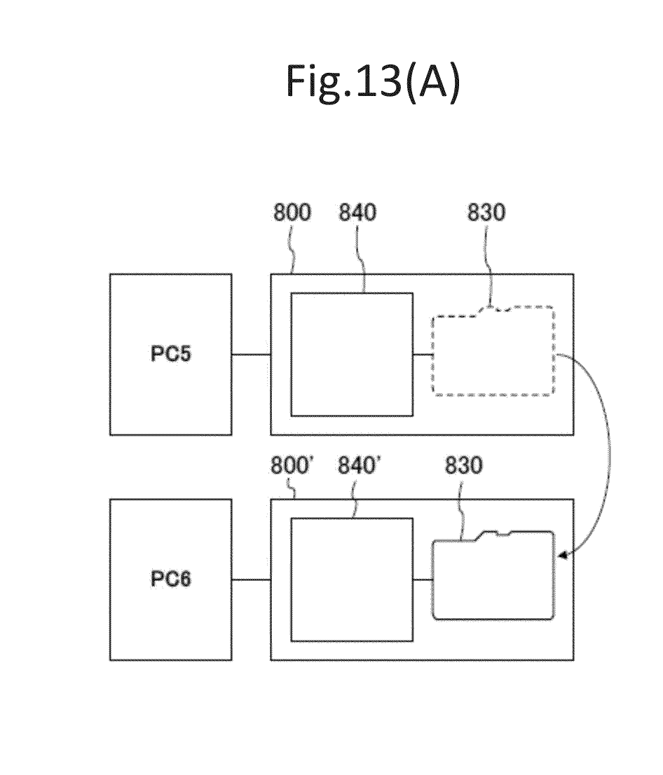

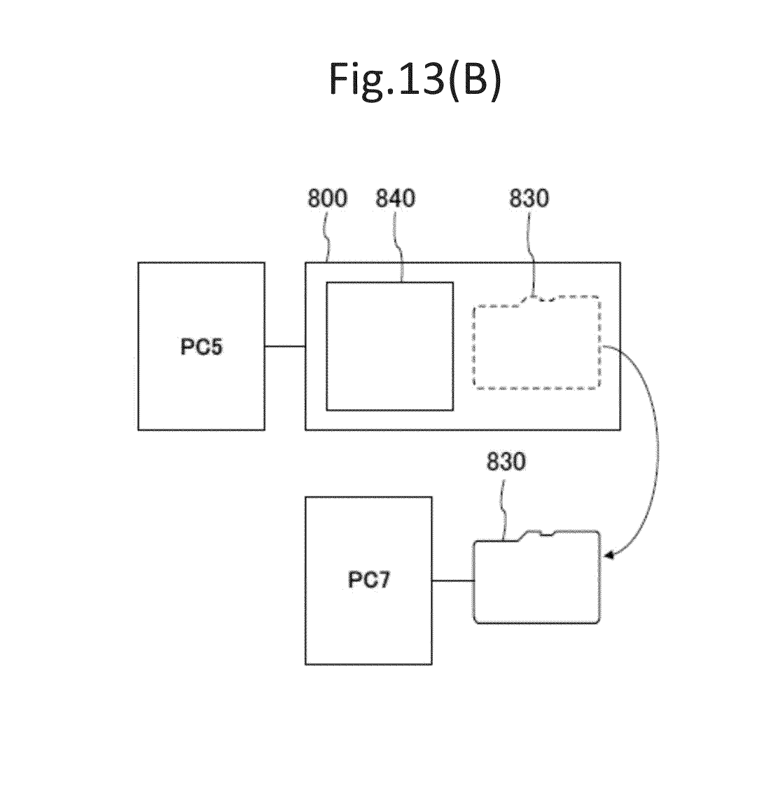

FIG. 13 shows examples of another use of storage devices in an embodiment according to the present invention. In FIG. 13, the first storage device is detachable. FIG. 13(A) shows a state where a micro SD card 830 is used to transfer data between a party having a storage device 800 and a party having a storage device 800′. The storage devices 800 and 800′ include a second controller 840 and a second controller 840′ respectively and use the detachable micro SD card 830 as the first storage device. In such a case, it is desirable to perform the conversion between the logical address and the physical address described in embodiment 3 or the encryption process described in embodiment 5. The storage device 800 is used as being connected with a personal computer PC5, and the storage device 800′ is used as being connected with a personal computer PC6. The personal computer PC5 and the personal computer PC6 may be the same as each other.

Referring to FIG. 13(B), a mala fide third party may possibly acquire the micro SD card 830 and connect the micro SD card 830 to a personal computer PC7 to read the contents thereof. Even in this case, analysis of the read data is difficult because the encryption or the address conversion has been performed. In the case where invalid data is written as in embodiment 1 or embodiment 2, recovery of the data of the deleted file may be impossible.

### Application Example 3

In the case where the first storage device in a storage device in an embodiment according to the present invention is fixed, it is conceivable that a mala fide third party disassembles the storage device to remove the first storage device and analyzes the stored contents. Even in such a case, as long as the conversion between the logical address and the physical address described in embodiment 3 or the encryption process described in embodiment 5 has been performed, the analysis is difficult. In the case where invalid data is written as in embodiment 1 or embodiment 2, recovery of the data of the deleted file may be impossible.

### REFERENCE SIGNS LIST

10: Nonvolatile memory
20: First controller
30: First storage device
40, 340, 440, 540, 640, 740, 840′: Second controller
41: Controller
45: Encryption block
300, 950, 3110: USB memory
301: SEM controller unit
330, 630, 830: Micro SD card
341, 910, 1010: CPU
342: RAM
380: Connection terminal
390: Connector
400, 430, 500: eMMC package
510: NAND flash memory
520: eMMC controller
730: HDD
600, 700, 800, 800′: Storage device
900, 2000: Information terminal
912: Memory controller
913: Graphic bus controller
914: Built-in graphic controller
920: Chip set
923: CPU bus
924: Display interface
930, 931: Semiconductor drive
932, 933, 951, 961, 971, 2210, 2310, 2520, 2610, 2720: Serial bus
935: Main memory
936, 2810, 2910: Memory bus
940: Graphic unit
941: Graphic bus
942, 2400; Display
943: Display output bus
960: Keyboard
970: Mouse
1000: External host
1020: Driver
2100: Application processor
2200: Wireless communication unit
2220: Antenna
2300: Sensor
2410: Touch panel interface unit
2420: Display interface unit
2500: Power source management unit
2510: Lithium ion battery
2600: Audio unit
2620: Speaker
2630: Microphone
2700: Camera module
2710: Two-dimensional CMOS sensor
2800: First memory
2900: Second memory
3100: SIM card

What is claimed is:

1. A storage device system, comprising:
a controller which is located between a driver controlling an interface between a nonvolatile memory and an external host and a controller of the nonvolatile memory, and detecting a logical address of an old data area for a deleted or overwritten file;
wherein the controller writes invalid data to the logical address of the old data area for the deleted or overwritten file.

2. The storage device system according to claim 1, wherein:
the controller holds backup of management information on the storage device system; and
the controller detects the logical address of the old data area for the deleted or overwritten file by comparing the management information and the backup against each other.

3. The storage device system according to claim 1, wherein the controller detects the logical address of the old data area for the deleted or overwritten file in an idle state, and writes the invalid data to the logical address of the old data area for the deleted or overwritten file.

4. The storage device system according to claim 1, wherein the controller writes the invalid data by encrypting original data written at the logical address of the old data area for the deleted or overwritten file and writing the encrypted data to the logical address of the old data area for the deleted or overwritten file.

5. The storage device system according to claim 1, wherein the controller outputs predetermined invalid data upon receiving, from the external host, a read command to read data from the logical address of the old data area for the deleted or overwritten file before completing writing the invalid data.

6. A storage device system, comprising:
a storage device including a nonvolatile memory and a first controller controlling the nonvolatile memory; and
an external host provided outside the storage device, the external host including a second controller controlling an interface with the storage device;
wherein the second controller detects a logical address of an old data area for a deleted or overwritten file, and writes invalid data to the logical address of the old data area for the deleted or overwritten file.

7. The storage device system according to claim 6, wherein:
the second controller holds backup of management information on the first controller; and
the second controller detects the logical address of the old data area for the deleted or overwritten file by comparing the management information and the backup against each other.

8. The storage device system according to claim 6, wherein the second controller detects the logical address of the old data area for the deleted or overwritten file in an idle state, and writes the invalid data to the logical address of the old data area for the deleted or overwritten file.

9. The storage device system according to claim 6, wherein the second controller writes the invalid data by encrypting original data written at the logical address of the old data area for the deleted or overwritten file and writing the encrypted data to the logical address of the old data area for the deleted or overwritten file.

10. The storage device system according to claim 6, wherein the second controller outputs predetermined invalid data upon receiving, from the external host, a read command to read data from the logical address of the old data area for the deleted or overwritten file before completing writing the invalid data.

11. A storage device system, comprising:
a storage device including a nonvolatile memory and a first controller controlling the nonvolatile memory; and
an external host provided outside the storage device, the external host including a second controller controlling an interface with the storage device;
wherein the second controller detects a logical address of an old data area for a deleted or overwritten file, and outputs predetermined invalid data upon receiving, from the external host, a read command to read data from the logical address of the old data area for the deleted or overwritten file.

12. The storage device system according to claim 11, wherein:
the second controller manages a physical address in the nonvolatile memory by use of a logical address-physical address conversion table;
the second controller invalidates correspondence between the logical address and the physical address in the conversion table upon detecting the logical address of the old data area for the deleted or overwritten file; and
the second controller outputs the predetermined invalid data upon receiving, from the external host, a read command to read data from a logical address, correspondence of the logical address with the physical address in the conversion table being invalidated

13. The storage device system according to claim 11, wherein:
the second controller holds a look-up table storing a part of management information on the nonvolatile memory; and
the second controller refers to the look-up table upon receiving the read command, and outputs the predetermined invalid data in the case where the read command is to read data from the logical address of the old data area for the deleted or overwritten file.

14. The storage device system according to claim 1, wherein:
the second controller encrypts write data received from the external host and writes the encrypted write data to the nonvolatile memory; and
the second controller decrypts the encrypted data written in the nonvolatile memory and transmits the decrypted data to the external host.

15. The storage device system according to claim 6, wherein:
the second controller encrypts write data received from the external host and writes the encrypted write data to the nonvolatile memory; and
the second controller decrypts the encrypted data written in the nonvolatile memory and transmits the decrypted data to the external host.

16. The storage device system according to claim 11, wherein:
the second controller encrypts write data received from the external host and writes the encrypted write data to the nonvolatile memory; and
the second controller decrypts the encrypted data written in the nonvolatile memory and transmits the decrypted data to the external host.
